(19) United States
(12) Patent Application Publication
(10) Pub. No.: US 2018/0276844 A1
(43) Pub. Date: Sep. 27, 2018

(54) POSITION OR ORIENTATION ESTIMATION APPARATUS, POSITION OR ORIENTATION ESTIMATION METHOD, AND DRIVING ASSIST DEVICE

(71) Applicant: CANON KABUSHIKI KAISHA, Tokyo (JP)

(72) Inventor: Takahiro Takahashi, Yokohama-shi (JP)

(21) Appl. No.: 15/915,587

(22) Filed: Mar. 8, 2018

(30) Foreign Application Priority Data
Mar. 21, 2017 (JP) 2017-054961

(51) Int. Cl. G06T 7/70; G06T 7/13; G06T 7/536; G08G 1/16

(52) U.S. Cl. CPC G06T 7/70; G06T 7/13; G06T 2207/30252; G08G 1/16; G06T 7/536

(57) ABSTRACT

A driving assist device acquires information from an imaging device and a ranging device and performs a process to assist driving of an automobile. A position or orientation estimation apparatus includes an image data plane detection unit configured to detect a plurality of plane regions from image information and first ranging information obtained by the imaging device ant a ranging data plane detection unit configured to detect a plurality of plane regions from second ranging information obtained by the ranging device. A position or orientation estimation unit estimates relative positions and orientations between the imaging device and the ranging device by performing alignment using a first plane region detected by the image data plane detection unit and a second plane region detected by the ranging data plane detection unit.

### FIELD OF THE INVENTION

The present invention relates to a technology for estimating positions or orientations of an imaging device with a ranging function and a ranging device.

### DESCRIPTION OF THE RELATED ART

In technologies for autonomously controlling moving objects such as automobiles or robots, processes of recognizing surrounding environmental by imaging devices and ranging devices mounted on the moving objects are performed. First, image information obtained from the imaging devices is analyzed, obstacles (vehicles, pedestrians, or the like) are detected, and distances to the obstacles are specified from distance information acquired by the ranging devices. Subsequently, processes of determining possibilities of collision with the detected obstacles are performed and action plans such as stopping or avoiding are generated. The moving objects are controlled according to the action plans. Such technologies are called driving assist, advanced driving assist systems (ADAS), and automatic driving which are functions of assisting driving of automobiles.

In control of driving assist, it is important to recognize information acquired by each of a plurality of devices in a unified manner without inconsistency. That is, a position or orientation relation between an imaging device and a ranging device is very important for a moving object that autonomously moves. However, in general, it is difficult for a ranging device to determine a measurement target since the number of measurement points is small, and association of distance information obtained from the imaging device and the ranging device is very difficult. In Zhang, Q, et al., “Extrinsic Calibration of a Camera and Laser Range Finder”, Proceeding of IEEE/RSJ international Conference on Intelligent Robots and Systems, 2003, a technology for changing installation locations many times (about 100 scenes in the document) to acquire the installation locations of a specific chart image and estimating positions or orientations of devices in manual association of regions corresponding to the chart image is disclosed. Non-Patent Literature 2 proposes an autonomous movement robot on which an imaging device with a ranging function and a ranging device are mounted and which recognizes the outside world with high precision and performs navigation. In H. Song, et. al., “Target localization using RGB-D camera and IA DAR sensor fusion for relative navigation”, Proceedings of International Automatic Control Conference (CACS), 2014, a method disclosed in Zhang, Q, et al., “Extrinsic Calibration of a Camera and Laser Range Finder”, Proceeding of IEEE/RSJ International Conference on Intelligent Robots and Systems, 2003 is used for estimation of positions and orientations of devices.

In the technologies of the related art, manual association of distance information is necessary in order to estimate a posit on or orientation relation between an imaging device and a ranging device regardless of whether the imaging device has the ranging function. Therefore, there is a problem that the manual association is considerably complicated and thus it takes much time. As a result, setting positions or orientations of the devices is performed only at the time of installation or adjustment. Accordingly, if the positions or orientations of the devices are changed over time or is changed accidentally due to collision or the like of a vehicle, there is a possibility of an automatic driving device not exhibiting a regular function unless readjustment is performed.

### SUMMARY OF THE INVENTION

According to the present invention, it is possible to simply estimate positions or orientations of an imaging device with a ranging function and a ranging device.

According to the present invention, a position or orientation estimation apparatus that estimates relative positions or orientations between an imaging device with a ranging function and a ranging device is provided that includes one or more processors; and a memory storing instructions which, when the instructions are executed by the one or more processors, cause the position or orientation estimation apparatus to function as units comprising: a first detection unit configured to detect a first plane region in an image from image information and first ranging information acquired by the imaging device; a second detection unit configured to detect a second plane region corresponding to the first plane region from second ranging information acquired by the ranging device; and an estimation unit configured to estimate positions or orientations of the imaging device and the ranging device by calculating a deviation amount between the first and second plane regions.

According to the present invention, the position or orientation estimation apparatus can simply estimate positions or orientations of an imaging device with a ranging function and a ranging device.

Further features of the present invention will become apparent from the following description of exemplary embodiments (with reference to the attached drawings).

### BRIEF DESCRIPTION OF THE DRAWINGS

FIG. 1 is a schematic view illustrating an example of a driving assist device according to an embodiment.

FIGS. 2A and 2B are schematic views illustrating an imaging device according to the embodiment.

FIGS. 3A to 3D are schematic views illustrating an image sensor according to the embodiment.

FIGS. 4A and 4B are explanatory diagrams illustrating a ranging method of the imaging device according to the embodiment.

FIGS. 5A to 5C are explanatory diagrams illustrating a relation between a positional deviation amount and a defocus amount.

FIG. 6 is a schematic view illustrating a ranging device according to the embodiment.

FIGS. 7A to 7C are flowcharts illustrating a position or orientation estimation process according to the embodiment.

FIGS. 8A and 8B are flowcharts illustrating S604 of FIG. 7A and driving assist control.

FIGS. 9A to 9G are schematic views for describing a plane detection method according to the embodiment.

FIGS. 10A and 10B are schematic views for describing a deviation between planes according to the embodiment.

FIGS. 11A to 11E are schematic views illustrating an installation situation of the imaging device and the ranging device.

### DESCRIPTION OF THE EMBODIMENTS

Hereinafter, embodiments of the present invention will be described in detail with reference to the drawings. The present invention relates to a technology for environment recognition of a moving object such as an automobile or a robot that can autonomously move and is available to recognize information acquired by an imaging device and a ranging device in an integrated manner. In the embodiment, an example of application to a driving assist device of an automobile will be described. The same reference numerals are given to the same or similar portions in principle in the description made with reference to the drawings, and the repeated description thereof will be omitted.

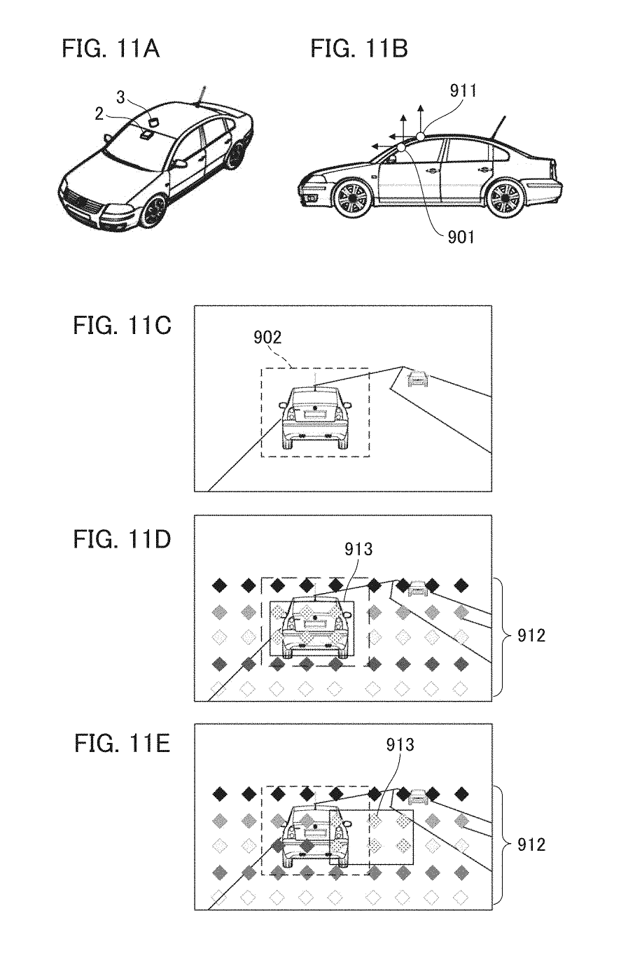

Before a configuration of the driving assist device is described, a position or orientation relation between the imaging device and the ranging device will be described in detail with reference to FIGS. 11A to 11E. FIG. 11A is a schematic view illustrating an installation situation of an imaging device and a ranging device in a vehicle. An imaging device 2 is installed inside a vehicle to normally acquire a clear image. For example, the imaging device 2 is mounted on an upper portion of a front window shield. A ranging device 3 is installed outside the vehicle because of a relation among a size, a ranging range, a ranging principle, and the like of the device. For example, the ranging device 3 is mounted at a position in a front end portion of a vehicle ceil in g portion on the assumption of a case in which the entire surrounding area of the ranging device 3 is set as a ranging range. Alternatively, if a ranging range is limited only to the front of the vehicle, a plurality of ranging devices are installed in a front nose portion of the vehicle in some cases.

In this way, in order to integrate information acquired from the imaging device 2 and the ranging device 3 installed to be separated from each other, it is necessary to ascertain a position or orientation relation of both the devices. FIG. 11B is a side view illustrating a coordinate system origin 901 of the imaging device 2 and a coordinate system origin 911 of the ranging device 3. It is necessary to measure a position or orientation relation between the coordinate system or gin 901 of the imaging device 2 and the coordinate system origin 911 of the ranging device 3, that is, a 3-dimensionally rotational amount R and a 3-dimensionally translational amount T between the origins, in advance.

A mode in which a distance between the vehicle and a front running vehicle is estimated will be described with reference to FIGS. 11C and 11D. FIG. 11C is a schematic view illustrating an image acquired by the imaging device 2. In the captured image, a region 902 in which the vehicle is located as an obstacle is detected. The distance to the front vehicle located in the region 902 is calculated using ranging information from the ranging device 3.

FIG. 11D illustrates a state in which ranging data 912 of the ranging device 3 is projected to the image obtained by the imaging device 2. A difference in color of a rhomboid indicates a difference n a distance. The distance to the front vehicle in the region 902 is calculated using the ranging data 912 in the region 902. In general, the region 902 is typically occupied by a detection target obstacle. For this reason, a mode value of ranging values in the region 902 is used. For example, a ranging value in a region 913 corresponding to the front vehicle is determined as a representative distance of the region 902. Based on the representative distance and a speed of the vehicle, a process of determining collision risk or the like is performed. FIG. 11D illustrates a case in which a deviation does not occur in the position or orientation relation between the imaging device 2 and the ranging device 3. The representative distance is assumed to accurately represent a distance to the front vehicle.

FIG. 11E illustrates a case in which a deviation occurs in the position or orientation relation between the imaging device 2 and the ranging device 3. That is, since the ranging data 912 of the ranging device 3 deviates to the right as a whole, a ranging value corresponding to the region 913 deviates from the region 902. In this state, with regard to the representative distance of the region 902, ranging data of the region 913 is not used and ranging data which is in the region 902 is used. In this example, a distance farther than the original distance to the front vehicle is calculated as a representative distance of the region 902. As a result, the representative distance is determined to be farther away and there is a possibility of collision risk being determined to be low.

Information regarding the positions or orientations of the imaging device 2 and the ranging device 3 is very important to a moving object that autonomously moves as in driving assist or the like. In general, for the ranging device 3, the number of measurement points is smaller, as illustrated in FIGS. 11D and 11E. For this reason, unlike an image acquired from the imaging device 2, it is difficult to determine what a measured target is and it is difficult to associate distance information acquired from the imaging device 2 and the ranging device 3.

Accordingly, in the embodiment, a process of simply estimating positions or orientations of the imaging device with the ranging function and the ranging device will be described. For example, a process of notifying a user of deviation in relative positrons or orientations between the imaging device and the ranging device based on an estimation result or a process of correcting ranging information according to a deviation amount is performed.

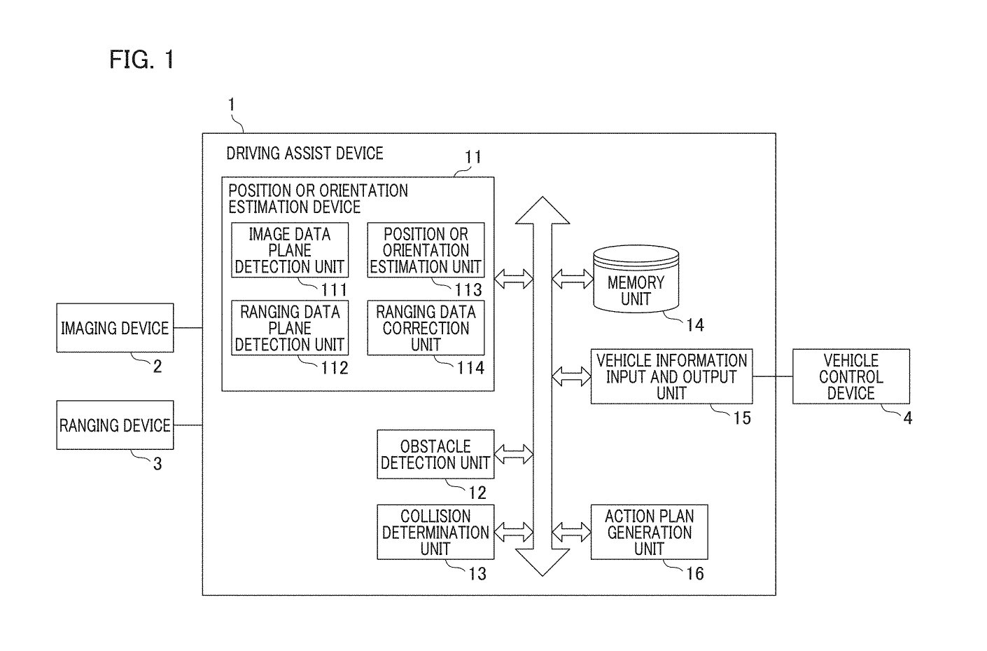

FIG. 1 schematically illustrates a configuration example if a position or orientation estimation apparatus of a vehicle between devices is applied to a driving assist device of a vehicle according to the embodiment. A driving assist device 1 includes a position or orientation estimation apparatus 11, an obstacle detection unit 12, a collision determination unit 13, a memory unit 14, a vehicle information input and output unit 15, and an action plan generation unit 16.

The position or orientation estimation apparatus 11 estimates a position or orientation relation between the imaging device 2 and the ranging device 3 connected to the driving assist device 1. The imaging device 2 has a ranging function and can acquire distance information from the imaging device 2 to a subject. The obstacle detection unit 12 detects obstacles such as vehicles, pedestrians, and bicycles of a surrounding environment. Information acquired from the imaging device 2 and the ranging device 3 is used to detect obstacles. The collision determination unit 13 acquires running state information such as a speed of the vehicle input from the vehicle information input and output unit 15 and information detected by the obstacle detection unit 12 and determines a possibility of collision between the vehicle and an obstacle. The action plan generation unit 16 generates an action plan for stopping or avoiding the obstacle based on a determination result of the collision determination unit 13. Vehicle control information based on the generated action plan is output from the vehicle information input and output unit 15 to a vehicle control device 4. The memory unit 14 temporarily stores image information or distance information input from the imaging device 2 and the ranging device 3 and stores a position or orientation on relation or dictionary information or the like used for the obstacle detection unit 12 to detect an obstacle. The vehicle information input and output unit 15 performs a process of inputting and outputting vehicle running information such as a vehicle speed or an angular velocity with the vehicle control device 4.

As a specific mounting form of the devices, either a mounting form by software (a program) or a mounting form by hardware can be used. For example, a program is stored in a memory of a computer (a microcomputer, a field-programmable gate array (FPGA), or the like) contained in the vehicle and the program is executed by the computer. A dedicated processor such as ASIC in which some or all of the processes according to the present invention are realized by a logic circuit may be installed.

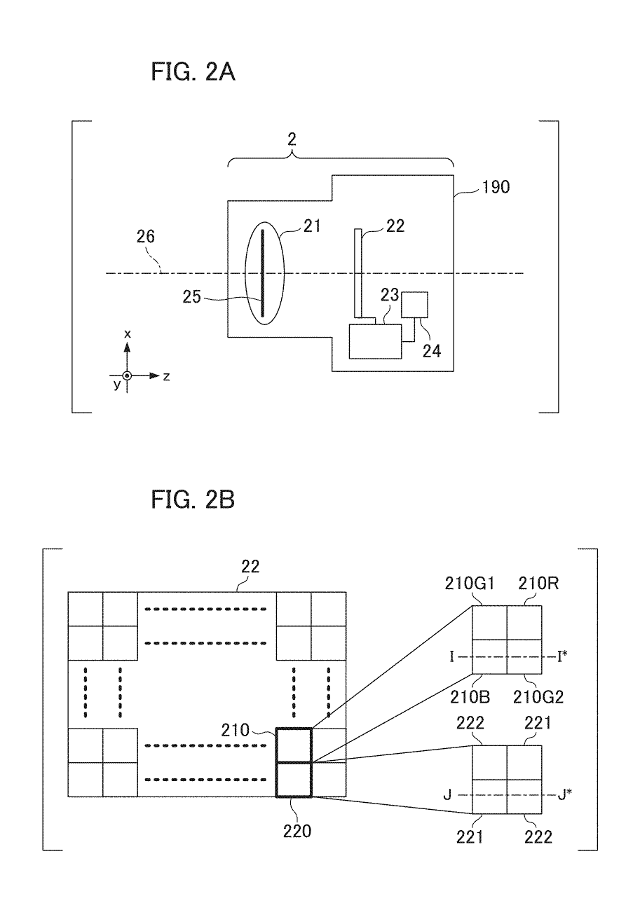

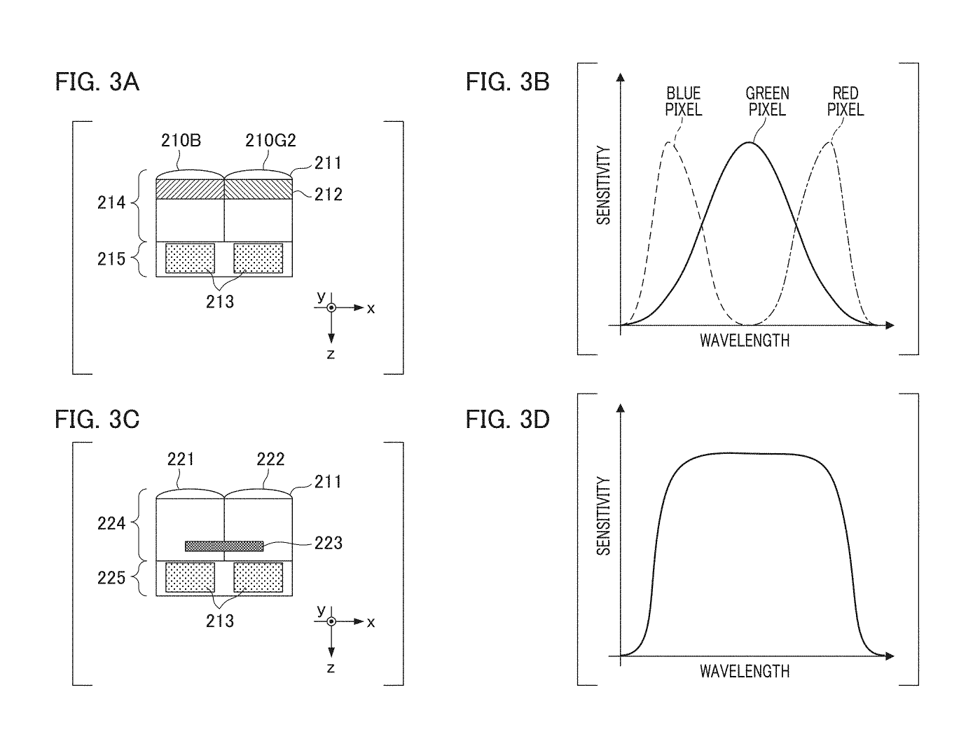

Next, a configuration of the imaging device 2 that has the ranging function will be described with reference to FIGS. 2A, 2B, and 3A to 3D. FIG. 2A is a schematic view illustrating the configuration of the imaging device 2. The imaging device 2 includes an optical image forming system 21 and an image sensor 22. A generation unit 23 that acquires an output signal of the image sensor 22 and generate image data and distance information, a driving control unit that drives an optical member such as a lens or an aperture, and a recording processing unit 24 that stores an image signal in a recording medium are disposed inside the imaging device 2.

The optical image forming system 21 forms an image of a subject on a light reception surface or the image sensor 22. The optical image forming system 21 includes a plurality of lens groups and includes an exit pupil 25 at a position distant by a predetermined distance from the image sensor 22. An optical axis 26 of the optical image forming system 21 illustrated in FIG. 2A is an axis parallel to the z axis, two axes perpendicular to the z axis are defined as the x and y axes, and the x and y axes are orthogonal to each other. The axis in the vertical direction of FIG. 2A is set as the x axis and the axis orthogonal to the sheet surface of FIG. 2A is set as the y axis.

Next, a configuration of the image sensor 22 will be described. The image sensor 22 is an image sensor in which a complementary metal-oxide semiconductor (CMOS) or a charge-coupled device (CCD) is used and has a ranging function in accordance with an imaging surface phase difference detection scheme. An image signal based on a subject image is generated by forming light from the subject on the image sensor 22 via the optical image forming system 21 and performing photoelectric conversion by the image sensor 22. The generation unit 23 performs a development process on the image signal acquired from the image sensor 22 to generate an image signal for viewing. The generated image signal for viewing is stored in a recording medium by the recording processing unit 24. Hereinafter, the image sensor 22 will be described in more detail with reference to FIGS. 2B and 3A to 3D.

FIG. 23 s a schematic view illustrating the configuration of the image sensor 22 if viewed in the z axis direction. The image sensor 22 is configured such that the plurality of pixel groups are arrayed in a 2-dimensional array form. An imaging pixel group 210 is a pixel group of 2 rows and 2 columns and is formed by green pixels 210G1 and 210G2 disposed in a diagonal direction and a red pixel 210R and a blue pixel 210B. The imaging pixel group 210 outputs a color image signal including three pieces of color information of blue, green, and red. In the embodiment, only the color information of the three primary colors of blue, green, and red has been described. However, color information with other wavelength bands may be used. A ranging (focal detection) pixel group 220 is a pixel group of 2 rows and 2 columns and is formed by a pair of first ranging pixels 221 disposed in a diagonal direction and a pair of second ranging pixels 222 disposed in another diagonal direction. The first ranging pixels 221 each output first image signal which is a ranging image signal and the second ranging pixels 222 each output a second image signal which is a ranging image signal.

FIG. 3A is a schematic view illustrating a cross-sectional structure of the imaging pixel group 210 and illustrates a cross-sectional surface of the blue pixel 210B and the green pixel 210G2 taken along the line I-I* of FIG. 2B. Each pixel includes a light-guiding layer 214 and a light-receiving layer 215. A microlens 211 and a color filter 212 are installed in the light-guiding layer 214. The microlens 211 efficiently guides a light flux incident on the pixel to a photoelectric conversion portion 213. The color filter 212 passes light with a predetermined wavelength bandwidth. The photoelectric conversion portion 213 is disposed in the light-receiving layer 215. Although wirings for image reading and pixel driving are additionally disposed, the wirings are not illustrated.

FIG. 3B illustrates characteristics of three kinds of color filters 212 of blue, green, and red. The horizontal axis represents a wavelength and the vertical axis represents sensitivity. Spectral sensitivity characteristics of the blue pixel 210B, the green pixels 210G1 and 210G2, and the red pixel 210R are indicated.

FIG. 3C is a schematic view illustrating a cross-sectional structure of the ranging pixel group 220 and illustrates a cross-sectional surface of first and second ranging pixels taken along the line J-J* of FIG. 2B. Each pixel includes a light-guiding layer 224 and a light-receiving layer 225. The light-guiding layer 224 includes a microlens 211 that efficiently guides a light flux incident on the pixel to the photoelectric conversion portion 213. A light-shielding portion 223 limits light incident on the photoelectric conversion portion 213. The photoelectric conversion portion 213 is disposed in the light-receiving layer 225. Additionally, wirings (not illustrated) for image reading and pixel driving are disposed. In the case of the ranging pixel group 220, no color filter is disposed. This is to eliminate a reduction of the light due to the color filter causes light.

FIG. 3D illustrates spectral sensitivity characteristics of the first and second ranging pixels. The horizontal axis represents a wavelength and the vertical axis represents sensitivity. The characteristics of the ranging pixels are spectral sensitivity characteristics obtained by multiplying spectral sensitivity of the photoelectric conversion portion 213 by spectral sensitivity of an infrared cutoff filter. Spectral sensitivity of the first and second ranging pixels is spectral sensitivity obtained by adding spectral sensitivity of the blue pixel 210B, the green pixel 210G1, and the red pixel 210R illustrated in FIG. 3B.

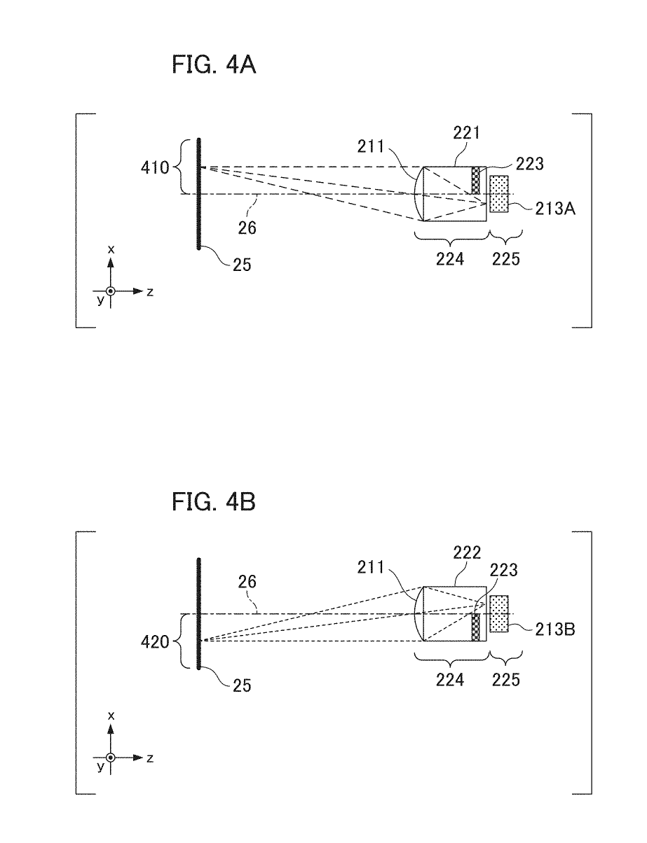

Next, a distance measurement principle of the imaging surface phase difference detection scheme will be described. Light fluxes received by the plurality of photoelectric conversion portions included in the image sensor 22 will be described with reference to FIGS. 4A and 4B. FIGS. 4A and 4B are schematic views illustrating the exit pupil 25 of the optical image forming system 21 and the first and second ranging pixels disposed in the image sensor 22. The axis in the vertical direction of FIG. 4A is set as the x axis, the axis orthogonal to the sheet surface of FIGS. 4A and 4B is set as the y axis, and the direction of the z axis in the horizontal direction is set as an optical axis direction. The microlens 211 in the pixel is disposed so that the exit pupil 25 and the light-receiving layer 225 have an optically conjugate relation. As a result, in FIG. 4A, a light flux passing through a first pupil region 410 contained in the exit pupil 25 is incident on the photoelectric conversion portion 213 of the first ranging pixel 221 (referred to as a first photoelectric conversion portion 213A). In FIG. 4B, a light flux passing through a second pupil region 420 contained in the exit pupil 25 is incident on the photoelectric conversion portion 213 of the second ranging pixel 222 (referred to as a second photoelectric conversion portion 213B).

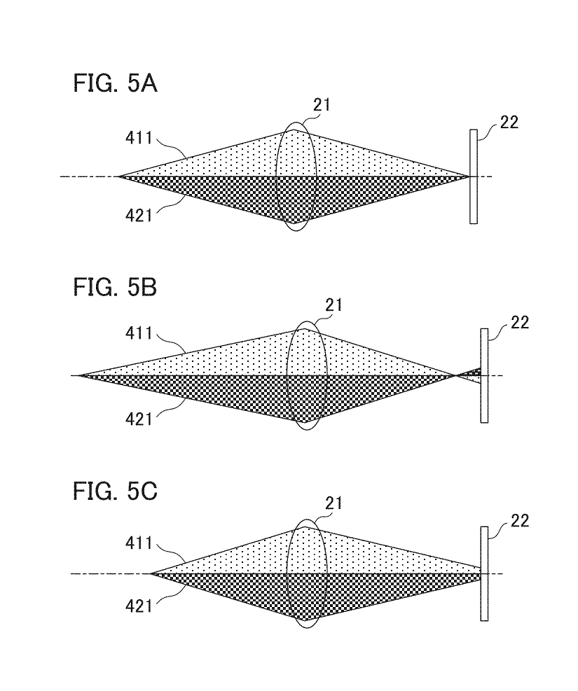

The first photoelectric conversion portion 213A installed in each pixel photoelectrically converts the received light flux to generate a first image signal. The second photoelectric conversion portion 213B installed in each pixel photoelectrically converts the received light flux to generate a second image signal. From the first image signal, an intensity distribution of an image formed on the image sensor 22 by the light flux mainly passing through the first pupil region 410 can be obtained. From the second image signal, an intensity distribution of an image formed on the image sensor 22 by the light flux mainly passing through the second pupil region 420 can be obtained. A relative positional deviation amount between the first and second image signals is an amount corresponding to a defocus amount. A relation between the positional deviation amount and the defocus amount will be described with reference to FIGS. 5A to 5C. FIGS. 5A to 5C are schematic views illustrating an image formation state and a positional relation between the image sensor 22 and the optical image forming system 21. A light flux 411 in the drawings indicates a first light flux passing through the first pupil region 410 and a light flux 421 indicates a second light flux passing through the second pupil region 420. FIG. 5A illustrates a focus state and FIGS. 5B and 5C indicate defocus states.

In the focus state illustrated in FIG. 5A, the first light flux 411 and the second light flux 421 are converged on a light reception image of the image sensor 22. At this time, a relative positional deviation amount between the first image signal formed by the first light flux 411 and the second image signal formed by the second light flux 421 is zero. On the other hand, FIG. 5B illustrates a front focus state in which the light fluxes are defocused in the negative direction of the z axis on the image side. At this time, the relative positional deviation amount between the first image signal formed by the first light flux and the second image signal formed by the second light flux is not zero and is a negative value. FIG. 5C illustrates a rear focus state in which the light fluxes are defocused in the positive direction of the z axis on the image side. At this time, the relative positional deviation amount between the first image signal formed by the first light flux and the second image signal formed by the second light flux is not zero and is a positive value.

As can be understood from comparison between FIGS. 5B and 5C, the direction of the positional deviation is exchanged according to the sign (positive and negative) of a defocus amount. From a geometric optical relation, it can be understood that a positional deviation occurs depending on a defocus amount. Accordingly, the positional deviation amount between the first and second image signals can be detected by a region-based matching method to be described below and the detected positional deviation amount can be converted into a defocus amount through a predetermined conversion coefficient. Conversion from the defocus amount on the image side to a subject distance on the object side can be easily performed using an image formation relation expression of the optical image forming system 21. The conversion coefficient for converting the positional deviation amount into the defocus amount depends on an angle of incidence of light reception sensitivity of the pixels included in the image sensor 22 and is determined in accordance with the shape of the exit pupil 25 and a distance between the exit pupil 25 and the image sensor 22.

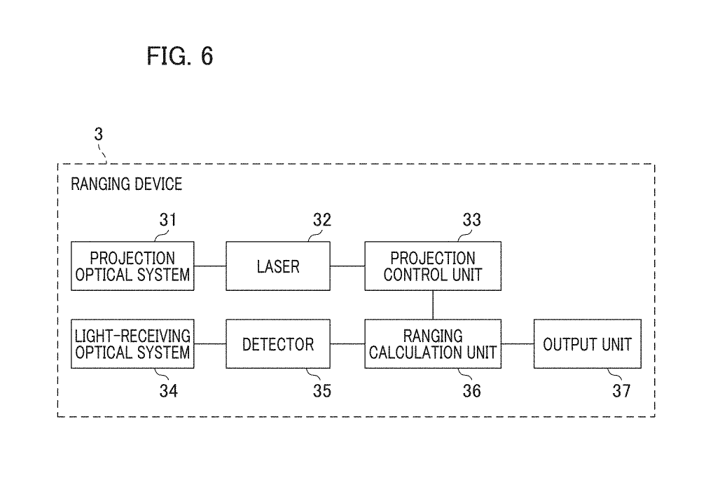

Next, a configuration example of the ranging device 3 will be described with reference to FIG. 6. The ranging device 3 includes constituent units of a light projecting system and a light-receiving system. The light projecting system includes a projection optical system 31, a laser 32, and a projection control unit 33. The light-receiving system includes a light-receiving optical system 34, a detector 35, a ranging calculation unit 36, and an output unit 37.

The laser 32 is a semiconductor laser diode that emits pulsed laser light. The light from the laser 32 is condensed and radiated by the projection optical system 31 that has a scanning system. In the embodiment, a semiconductor laser is used, but the present invention is not particularly limited. Any of various lasers can be used as long as user light with good directivity and convergence can be obtained. However, laser light with an infrared wavelength band is preferably used in consideration of safety. The projection control unit 33 controls emission of the laser light by the laser 32. The projection control unit 33 generates a signal for causing the laser 32 to emit light, for example, a pulsed driving signal, and outputs the signal to the laser 32 and the ranging calculation unit 36. A scanning optical system included in the projection optical system 31 scans the laser light emitted from the laser 32 at a predetermined period in the horizontal direction. The scanning optical system has a configuration in which a polygon mirror, a galvanometer mirror, or the like is used. If driving assist of an automobile is a purpose, a laser scanner that has a structure in which a plurality of polygon mirrors are stacked in the vertical direction and a plurality of pieces of laser light arranged in the vertical direction are scanned horizontally is used.

An object (detection object) to which the laser light is radiated reflects the laser light. The reflected laser light is incident on the detector 35 via the light-receiving optical system 34. The detector 35 includes a photodiode which is a light-receiving element and outputs an electric signal with a voltage value corresponding to the intensity of the reflected light. The signal output from the detector 35 is input to the ranging calculation unit 36. The ranging calculation unit 36 measures a time from a time point at which the driving signal of the laser 32 is output from the projection control unit 33 until a light reception signal detected by the detector 35 is generated. The time is a time difference between a time at which the laser light is emitted and a time at which the reflected light is received and is equivalent to double of a distance between the ranging device 3 and the detection object. The ranging calculation unit 36 performs calculation to convert the time difference object into a distance to the detection and acquires a distance to an object from which radiated electromagnetic waves are reflected.

Next, the configuration of the position or orientation estimation apparatus 11 in FIG. 1 will be described. An image data plane detection unit 111 extracts a region which is a candidate for a plane region (hereinafter referred to as a plane candidate region) from the image data and the ranging information acquired by the imaging device 2. A plan region is detected in the plane candidate region. A ranging data plane detection unit 112 extracts a plane candidate region from the ranging information acquired by the ranging device 3 based on the plane candidate region detected by the image data plane detection unit 111 and detects a plane region. A position or orientation estimation unit 113 estimates positions or orientations of the imaging device 2 and the ranging device 3 based on results detected by the image data plane detection unit 111 and the ranging data plane detection unit 112.

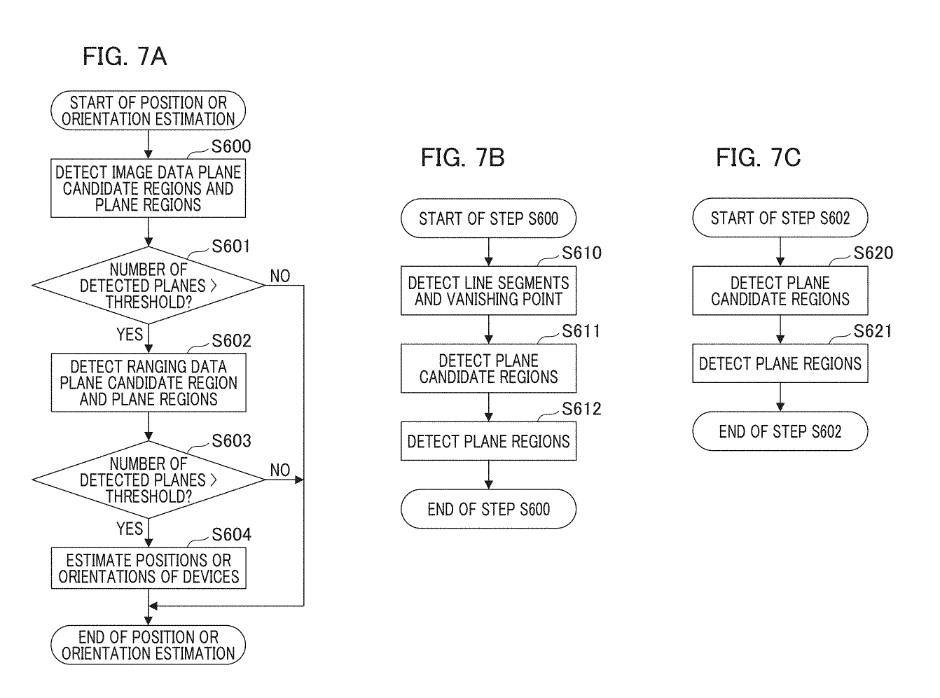

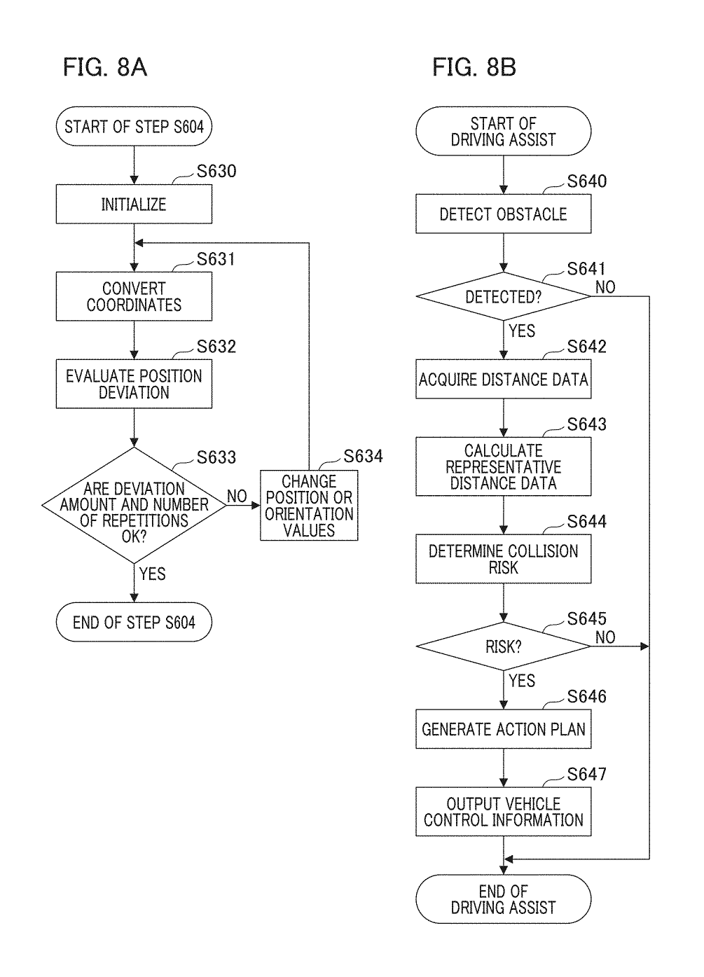

A flow of a position or orientation estimation process by the imaging device 2 and the ranging device 3 will be described with reference to the flowcharts of FIGS. 7A to 8B. The imaging device 2 and the ranging device 3 are installed in a vehicle to be located in substantially the same direction. A distance between the devices is assumed to be measured manually and distance information is assumed to be recorded in advance in the memory unit 14. Device-intrinsic correction with regard to image data and a ranging value output from each device is performed in each device. For example, for the image data, distortion or the like is corrected in the imaging device 2. For the ranging data, linearity or spatial homogeneity of a ranging value is corrected in the ranging device 3. This process starts, for example, if the user uses an instruction unit in the driving assist device 1 to perform an instruction operation of adjusting the position or orientation relation between the imaging device 2 and the ranging device 3.

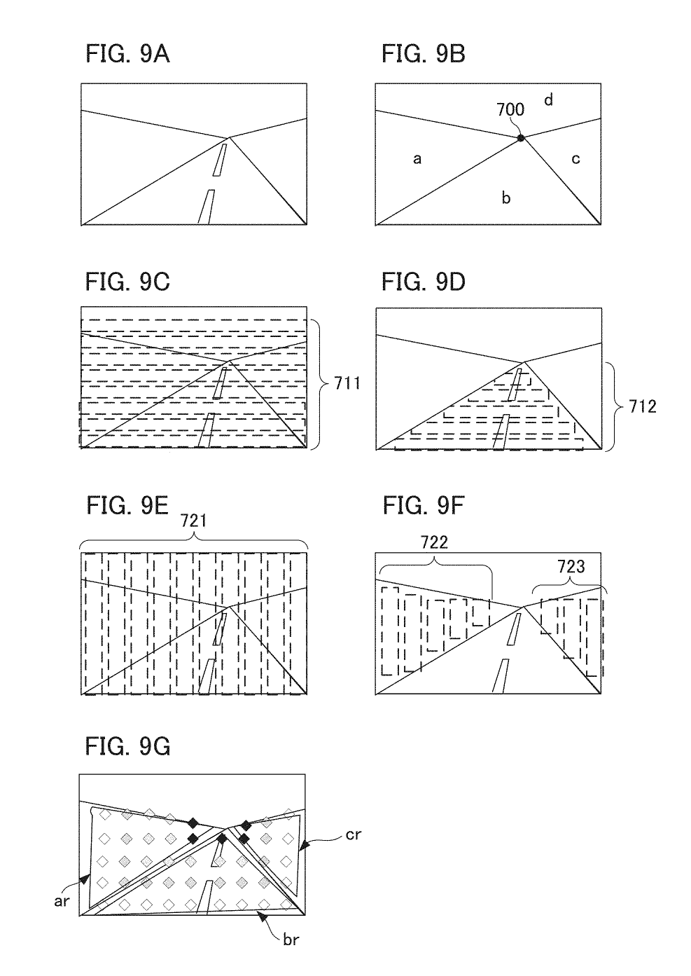

First, in step S600 of FIG. 7A, the image data plane detection unit 111 detects the plane candidate regions and the plane regions using the image data and the ranging data acquired from the imaging device 2. In the detection, since the image data and the ranging data from the imaging device 2 have a higher in-plane resolution than those of the ranging device 3, the imaging device 2 is suitable to detect a structure such as a plane. The details of the process of step S600 will be described later with reference to FIGS. 7B and 9A to 9G.

Subsequently, in step S601, the position or orientation estimation apparatus 11 compares the number of plane regions detected in step S600 with a predetermined threshold based on the image data and the ranging data from the imaging device 2. If the number of plane regions is considerably greater than the predetermined threshold, a processing time is lengthened. Conversely, if the number of plane regions is considerably less than the predetermined threshold, there is a possibility of precision of the position or orientation estimation between the devices on the rear stage deteriorating. Therefore, the number of plane regions is set within a range of about 2 to 10. If the number of plane regions is equal to or less than the threshold, a process of displaying the fact that the number of plane regions is less than the threshold on a screen of a display unit (not illustrated) is performed and the process subsequently ends. If the number of plane regions detected in step S600 is greater than the threshold, the process proceeds to step S602.

Instep S602, the ranging data plane detection unit 112 performs plane detection using the ranging information obtained by the ranging device 3, extracts the plane candidate regions, and detects the plane regions. At this time, the process can be stably performed by using information regarding the plane candidate regions detected in step S600 and initial position orientation information at the time of installation of the device stored in the memory unit 14. The details of the process will be described later with reference to FIG. 7C.

In step S603, the position or orientation estimation apparatus 11 determines whether the number of plane regions detected in step S602 is greater than the threshold by comparing the number of plane regions with the threshold. The threshold is set within a range of, for example, about 2 to 10. If the number of plane regions detected in step S602 is equal to or less than the threshold, a process of displaying the fact that the number of plane regions is equal to or less than the threshold on a screen of the display unit (not illustrated) is performed and the process subsequently ends. If the number of plane regions detected in step S602 is greater than the threshold, the process proceeds to step S604.

In step S604, the position or orientation estimation unit 113 estimates the positions or orientations of the imaging device 2 and the ranging device 3 based on a correspondence relation between the plane candidate regions and the plane regions detected in steps S600 and S602, and then the process ends. The details of the process will be described later with reference to FIG. 8A.

The process of step S600 of FIG. 7A will be described with reference to FIGS. 7B and 9A to 9G. FIG. 7B is a flowchart illustrating an example of the process and FIGS. 9A to 9G are schematic views illustrating image examples.

In step S610 of FIG. 7B, a line segment and a vanishing point are detected based on the image data acquired by the imaging device 2. A specific example will be described with reference to FIGS. 9A and 9B. In a specific process of detecting straight lines (accurately, line segments) in the image and detecting vanishing points from the straight lines, a lowpass filter (LPF) process, an edge detection process, and a line segment detection process are performed on the acquired image data. The vanishing points are detected from intersections of the plurality of detected line segments. In the LPF process, a process with a smoothing effect, such as Gaussian filtering, is performed to suppress an unnecessary form or a noise component for the detection of the line segments. In the edge detection process, an edge component is detected using a Canny operator, a Sobel filter, or the like. In the line detection process, an edge component with a high possibility of being a straight line is extracted using Hough conversion. Results of these processes are illustrated in FIG. 9A. Thereafter, to detect the plane candidate regions with certain sizes, line segments with lengths equal to or greater than a predetermined threshold are detected. The detected line segments, points converged on substantially one point are detected as vanishing points. In the example of FIG. 9B, a vanishing point 700 is detected from four line segments.

In step S611 of FIG. 75, the plane candidate regions are detected. The plane candidate region is a region demarcated by the detected segment lines. In the example of FIG. 9B, four straight lines are detected with regard to the vanishing point 700. Regions a to d interposed by the four straight lines are detected as four plane candidate regions.

Subsequently, in step S612, the plane regions are detected using the plane candidate regions detected in step S611 and ranging values acquired from the imaging device 2. As illustrated in FIGS. 9A to 9G, planes extending in the depth direction of a road or the like have substantially the same distance in the horizontal direction of the screen. On the other hand, the planes extending in the height direction as in a wall or the like have substantially the same distance in the vertical direction of the screen. The plane regions can be detected using such features. Specifically, as illustrated in FIGS. 9C and 9E, a process of segmenting the screen into a plurality of partial region groups is performed. FIG. 9C illustrates an example of a partial region group 711 extending in the horizontal direction and FIG. 9E illustrates an example of a partial region group 721 extending in the vertical direction. Since the ranging data by the imaging device 2 is acquired in the same axis as the image, regions which can be viewed to have substantially the same ranging value can be specified for each partial region in the vertical direction and the horizontal direction. FIG. 9D corresponds to FIG. 9C and illustrates an example of a partial region group 712 in the region b. FIG. 9F corresponds to FIG. 9E and illustrates a partial region group 722 in the region a and an example of a partial region group 723 in the region c. The plane regions are detected by integrating the results and the regions a to d detected in step S611. Specifically, ranging values of the partial region groups 722, 712, and 723 respectively corresponding to the regions a, b, and c illustrated in FIG. 9B are acquired and become ranging values belonging to the plane regions. The image data plane detection unit 111 analyzes the image and the ranging values obtained from the imaging device 2 through the foregoing process, specifies and extracts the plane candidate regions based on the analysis result, and detects the plane regions.

The process of step S602 of FIG. 7A will be described with reference to FIGS. 7C and 9A to 9G. FIG. 7C is a flowchart illustrating an example of the process. First, in step S620, a process of segmenting the ranging data acquired by the ranging device 3 into regions for which it is determined whether the regions are planes. For the ranging data, a method of determining whether the regions are the plane in a round-robin manner is possible, but it takes some take to perform the process. Accordingly, in order to improve detection precision while shortening a processing time, information regarding the plane regions detected in step S600 is used. Here, the ranging data by the ranging device 3 is denoted by Xᵣ. A rotational amount and a translational amount from an origin Xᵣ₀ of the ranging device 3 to an origin Xᵢ₀ of the imaging device 2 are denoted by R_{rc} and T_{rc}.

Coordinate conversion in the case of conversion of the ranging data Xᵣ into data on the coordinate system of the ranging data of the imaging device 2 can be expressed in accordance with the following Formula.

X_{rc}M·Xᵣ, where M=[R_{rc},T_{rc};0,1]

Next, a process of projecting all of the ranging data Xᵣ of the ranging device 3 to an image of the imaging device 2 is performed. This can be calculated with a camera matrix K in accordance with “xᵣᵢ=K·X_{rc}.” The camera matrix K is a matrix of 4 rows and 4 columns expressing a main point, a focal distance, distortion, and the like if a 3-dimensional space is projected to 2-dimensional image coordinates and is assumed to be measured in advance as a device eigenvalue An overview is illustrated in FIG. 9G. FIG. 9G illustrates a mode in which the ranging data by the ranging device 3 is projected to the image and a difference in color of a rhomboid in the drawing indicates a difference in a distance. Here, a grouping process is performed by determining which region the ranging data enters among the plane regions a, b, and c detected from the information by the imaging device 2 in step S612. Here, since the ranging data projected to the image can be obtained using initial values of the positions or orientations of the devices, each region may have a margin with a certain size and may also overlap each region.

The process proceeds to step S621 and a process of detecting the plane regions in each group of the ranging data segmented in step S620 is performed. In this detection, a method such as a least squares method, a robust estimation method, or a random sample consensus (RANSAC) is used. In this process, if the number of detected ranging points is equal to or less than a threshold, it is determined that the plane regions may not be detected in the group and the detection moves to ranging data in which there are the plane regions of another group. The results are shown in data groups ar, br, and cr of FIG. 9G. In this way, the ranging data from the ranging device 3 can be classified into plane candidate regions.

In the embodiment, a distance to the detected object is estimated using the positions or orientations estimated by the position or orientation estimation apparatus 11 to determines a collision possibility. To perform the driving assist, a process of integrating the ranging data of the ranging device 3 into the coordinate system obtained by the imaging device 2 and obtaining position or orientation information is performed. The coordinate system may not necessarily be integrated with the coordinate system obtained by the imaging device 2. The coordinate system may be integrated with any coordinate system such as a coordinate system of the ranging device 3 or the coordinate system in which a predetermined position of a vehicle is set as a reference. The description thereof will be made with reference to FIG. 8A.

First, in step S630, the position or orientation estimation apparatus 11 initialize the position or orientation information stored in the memory unit 14, that is, a rotational amount R₀ (a matrix of 3 rows and 3 columns) and the translation T₀ (3 rows and 1 column), to initial values R and T, as in step S620 of FIG. 7C. Subsequently, in step S631, a process of converting the ranging data of the ranging device 3 into data on the coordinate system, of the imaging device 2 is performed as in Formula 1.

X_{rc}=M·Xᵣ (Formula 1)

Here, Xᵣ is coordinates of a ranging point of the ranging device 3 and M is a matrix of 4 rows and 4 columns in which the rotational matrix and a translational vector T are composited, as in Formula 2.

M=[R,T;0,1] (Formula 2)

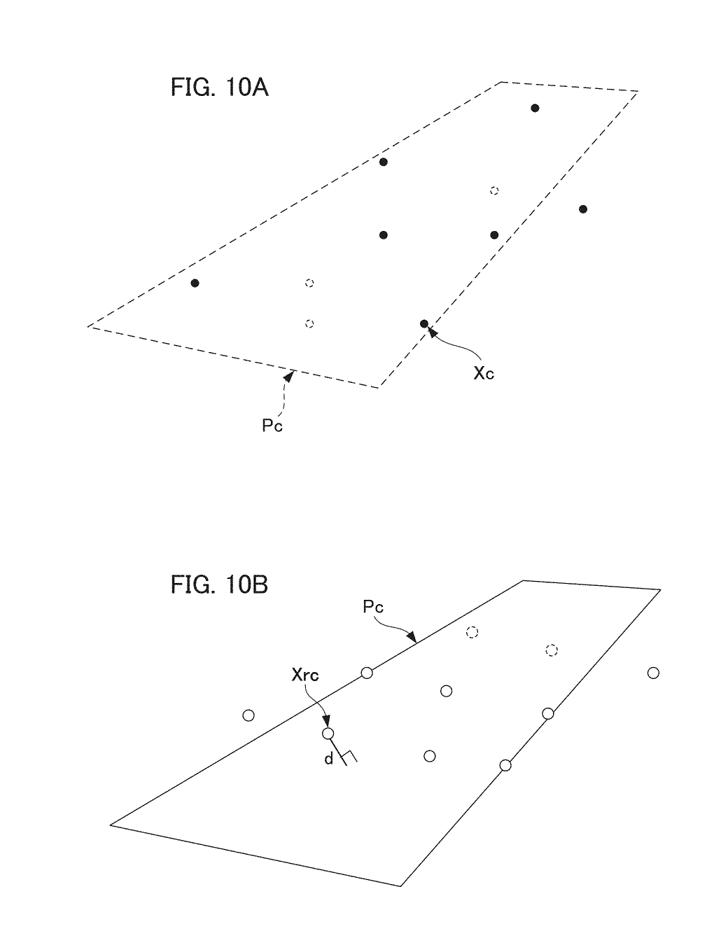

Subsequently, the process proceeds to step S632 to evaluate a position deviation between the plane region of the ranging data detected in step S600 and the plane region of the image data detected in step S602. This mode will be described specifically with reference to FIGS. 10A and 10B. FIG. 10A illustrates ranging data X_{c} and a plane P_{c} of the imaging device 2. FIG. 10B illustrates a positional relation between the ranging data X_{rc} and the plane P_{c}.

First, the position or orientation estimation apparatus 11 estimates the plane P_{c} (ax_{c}+by_{c}+cz_{c}+d=0) using the ranging data X_{c} of the imaging device 2 belonging to the plane region detected in step S600. In the estimation, a method such as a least squares method, a robust estimation method, or a random sample consensus (RANSAC) is used. The estimation process is performed for each of the detected plane groups. Subsequently, the position or orientation estimation apparatus 11 defines a distance between the planes. A distance between the ranging data X_{rc} of the ranging device 3 detected in step S602 and converted into the coordinate system of the imaging device 2 and a foot of a perpendicular Line in an equation of the estimated plane is set as d. A distance between the planes is defined using the distance d. A distance between the plane Pc and the point X_{rc} (x_{cr}, y_{rc}, z_{rc}) is defined as in Formula 3.

δ=|ax_{rc}+bx_{rc}+cz_{rc}+d|√(a²+b²+c²) (Formula 3)

The distances are summed for the ranging points belonging to each plane group of the detected plane groups in accordance with Formula 4 and the sum is set as a deviation amount by the rotational amount R and the translational amount T between the current devices.

D=ΣₚΣₓ(δ) (Formula 4)

Subsequently, the process proceeds to step S633. The position or orientation estimation apparatus 11 determines whether the deviation amount D is equal to or less than a predetermined threshold and the process is repeated a predetermined number of times. If the deviation amount D equal to or less than the predetermined threshold, it is determined that the positions or orientations has been correctly estimated and the process ends. If the deviation amount D is greater than the predetermined threshold, the process proceeds to step S634. Here, if the process is repeated a predetermined number of times despite the fact that the deviation amount D is greater than the predetermined threshold, it is determined that the positions or orientations may not be estimated and the process ends.

In step S634, in order to reduce the deviation amount D, the position or orientation estimation apparatus 11 updates the matrix Id to a matrix M* as shown in Formula 5, that is, the rotation R and the translation T.

M*=argmin_{M}∥D∥=argmin_{M}∥ΣₚΣₓ(δ)∥ (Formula 5)

In the minimization, the matrix is updated using a known method such as Levenberg-Marguartdt.

As described above, the position or orientation relation between the imaging device 2 and the ranging device 3 can be calculated based on the image obtained from the imaging device 2 and the analysis of each ranging device. The example in which the ranging data of the ranging device 3 is converted into the data on the coordinate system of the imaging device 2 has been described above, but the opposite can be realized or the conversion can be realized with any coordinate system such as a coordinate system serving as a reference of the vehicle. For the deviation in the planes, the equation of the planes may be estimated in each of the plane regions detected with each piece of ranging data and any distance such as a deviation between normal lines of the correspond planes or an angle at which the planes intersect each other may he defined. For a method of changing the rotation and the translation, the rotation and the translation may be simultaneously changed or each of the rotation and the translation may be changed. As in the embodiment, if the orientation of each device is installed in substantially the same manner, the present invention is not particularly limited. For example, a translation, amount is mainly adjusted.

An operation of the driving assist device 1 that detects an obstacle using an estimation result by the position or orientation estimation apparatus 11 and performs a warning if there is a risk will he described with reference to the flowchart of FIG. 8B. In step S640, the process starts from a location at which a travelling obstacle such as a vehicle or a pedestrian is detected from the image data acquired by the imaging device 2. There is a detection method of pattern matching using image data of obstacles registered in advance or a detection method of identifying an image feature amount such as SIFT or HOG with teaching, data learned in advance. SIFT is an abbreviation for “Scale-Invariant Feature Transform” and HOG is an abbreviation for “Histograms of Oriented Gradients.” If the obstacle detection unit 12 detects an obstacle in step S641, the process proceeds to step S642. If no obstacle is detected, the process ends.

In step S642, ranging data to the detected obstacle is acquired. Specifically, the obstacle is detected in the region 902 in the image of FIG. 11C. The ranging data obtained by projecting the ranging data obtained by the imaging device 2 corresponding to a region surrounded by a dotted line and the ranging data obtained by the ranging device 3 to an image using the camera matrix and the position or orientation information in the memory unit 14 is selected. If a plurality of obstacles are detected, ranging data of the imaging device 2 and the ranging device 3 in a region in which each obstacle is detected is selected.

Subsequently, in step S643, the obstacle detection unit 12 calculates a representative distance to the region of the detected obstacle using the ranging data selected in step S642. Specifically, a ranging value and the degree of reliability indicating reliability of each piece of ranging data are used. For the ranging data acquired by the imaging device 2, reliability of the ranging value in a region such as an edge in which there is texture is high, but the reliability is low in a region in which there is no texture in terms of the ranging principle. On the other hand, the ranging data acquired by the ranging device 3 does not depend on texture and the reliability is high if an object has high reflectivity. The number of ranging points of the ranging device 3 is less than the number of ranging points of the imaging device 2. A process of calculating a representative ranging value is performed using a statistic amount such as a mode value as a statistic amount of the ranging data with high reliability.

In step S644, the collision determination unit 13 determines a risk of collision with the obstacle from the representative ranging value calculated in step S643 and vehicle speed data input via the vehicle information input and output unit 15. If it is determined in step S645 that the risk of the collision is high, the process proceeds to step S646. If it is determined that there is no risk, the process ends.

In step S646, the action plan generation unit 16 generates an action plane. In the action plane, there is, for example, control performed for emergency stop in accordance with a distance to an obstacle, a process of giving a warning to a driver, and control performed for an avoiding route in accordance with a surrounding situation. In step S647, the vehicle information input and output unit 15 outputs acceleration and an angular velocity of a vehicle determined based on the action plane generated in step S646, that is, information regarding a control amount of an accelerator or a brake or a steering angle of a steering wheel, to the vehicle control device 4. The vehicle control device 4 performs running control, a warning process, and the like.

In the embodiment, a driving assist function such as obstacle detection can be realized with high precision using the position or orientation relation between the imaging device 2 and the ranging device 3. With regard to the position or orientation estimation function, an instruction by a driver or an automatic process starts during a long-time stop such as a signal standby state or in the case of an accidental collision with a vehicle. For example, the position or orientation estimation apparatus 11 acquires speed information of the vehicle from the vehicle information input and output unit 15, estimates the positions or orientations if a stop state of the vehicle continues for a predetermined threshold time or more, and performs a process of notifying a driver that the positions or orientations of the imaging device 2 and the ranging device 3 are changed. Alternatively, a process of warning the driver about occurrence of a large deviation from the previously estimated positions or orientations of the imaging device 2 and the ranging device 3 is performed. For example, if the deviation between the detected plane regions is detected, the position or orientation estimation apparatus 11 displays a deviation of the positions or orientations of the imaging device 2 and the ranging device 3 from the previous setting on a screen of the display unit or performs a process of notifying the driver of the deviation through audio output. It is possible to obtain the effect of preventing the driving assist process from not correctly functioning due to the deviation in the positions or orientations caused by a temporal change between the devices, an accidental change, or the like.

According to the embodiment, it is possible to realize the simple estimation of the positions or orientations by acquiring the ranging information by the imaging device with the ranging function and the ranging information by the ranging device and performing alignment based on the plurality of detected plane regions.

### MODIFICATION EXAMPLES

According to a modification example of the imaging device capable of performing ranging, an image sensor that includes a plurality of microlenses and a plurality of photoelectric conversion portions corresponding to the microlenses is used instead of the image sensor that includes the light-shielding portions 223. For example, each pixel unit includes one microlens and two photoelectric conversion portions corresponding to the microlens. Each photoelectric conversion portion receives light passing through each of different pupil partial regions of an imaging optical system, perform photoelectric conversion, and outputs an electric signal. The phase difference detection unit can calculate a defocus amount or distance information from an image deviation amount by detecting a phase difference between a pair of electric signals. A system using a plurality of imaging devices can acquire distance information of a subject. For example, a stereo camera including two or more cameras can acquire images with different viewpoints and calculate a distance of a subject. The present invention is not particularly limited as long as an imaging device can acquire images and simultaneously perform ranging.

As another modification example, a ranging value is corrected by estimating a position or orientation relation between the imaging device with the ranging function and the ranging device and performing comparison with the unified coordinate system. In general, the ranging device 3 is stable in an environment and an optical system or the like of the imaging device 2 is changed depending on a condition such as a temperature in some cases. In this case, the ranging data correction unit 114 (see FIG. 1) in the position or orientation estimation apparatus according to the modified example corrects a ranging value of the imaging device 2 using the ranging value of the ranging device 3. At this time, if a plane region occupying in an imaging screen exceeds a half or more of the screen (for example, most of the imaging screen is a road or a building), the ranging data correction unit 114 calculates a correction coefficient according to the plane region and multiples a ranging value before correction by the correction coefficient.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-054961, filed Mar. 21, 2017 which is hereby incorporated by reference wherein in its entirety.

What is claimed is:

1. A position or orientation estimation apparatus that estimates relative positions or orientations between an imaging device with a ranging function and a ranging device, the position or orientation estimation apparatus comprising:
one or more processors; and
a memory storing instructions which, when the instructions are executed by the one or more processors, cause the position or orientation estimation apparatus to function as units comprising:
a first detection unit configured to detect a first plane region in an image from image information and first ranging information acquired by the imaging device;
a second detection unit configured to detect a second plane region corresponding to the first plane region from second ranging information acquired by the ranging device; and
an estimation unit configured to estimate positions or orientations of the imaging device and the ranging device by calculating a deviation amount between the first and second plane regions.

2. The position or orientation estimation apparatus according to claim 1,
wherein the first detection unit detects an edge component of the image captured by the imaging device, extracts candidate regions of the first plane region, and detects the first plane region using the first ranging information in each of the candidate regions.

3. The position or orientation estimation apparatus according to claim 2,
wherein the first detection unit detects a vanishing point from a plurality of components in the captured image and extracts the candidate regions of a plurality of the first plane regions.

4. The position or orientation estimation apparatus according to claim 2,
wherein the second detection unit extracts candidate regions of the second plane region from the second ranging information using the candidate regions of the first plane region.

5. The position or orientation estimation apparatus according to 1,
wherein the number of ranging points of the imaging device is greater than the number of ranging points of the ranging device.

6. The position or orientation estimation apparatus according to claim 1,
wherein the imaging device includes an image sensor that includes a plurality of microlenses and a plurality of photoelectric conversion portions corresponding to the microlenses and acquires the first ranging information from outputs of the plurality of photoelectric conversion portions.

7. The position or orientation estimation apparatus according to claim 1,
wherein the imaging device includes a plurality of imaging units with different viewpoints and acquires the first ranging information from outputs of the plurality of imaging units.

8. The position or orientation estimation apparatus according to claim 1,
wherein the estimation unit calculates the deviation amount between the first and second plane regions by performing rotational and translational operations using a coordinate system set in the imaging device or the ranging device or a coordinate system set in a moving object including the imaging device and the ranging device as a reference.

9. The position or orientation estimation apparatus according to claim 1, further comprising:
a correction unit configured to correct the first ranging information using the second ranging information if deviation between the first and second plane regions is detected.

10. The position or orientation estimation apparatus according to claim 1,
wherein the estimation unit performs a process of notifying that the positions or orientations of the imaging device and the ranging device have changed if deviation between the first and second plane regions is detected.

11. A driving assist device of a moving object including the position or orientation estimation apparatus according to claim 1, the driving assist device comprising:
one or more processors; and
a memory storing instructions which, when the instructions are executed by the one or more processors, cause the driving assist device to function as units comprising:
a third detection unit configured to detect a position of a detection object in an image using image information acquired from an imaging device and calculate a distance to the detection object using first ranging information, second ranging information, and information regarding a position or orientation estimated by the position or orientation estimation apparatus; and
a determination unit configured to determine whether collision occurs between the moving object and the detection object detected by the third detection unit.

12. The driving assist device according to claim 11,
wherein the estimation unit estimates the position or orientation if the moving object is stopping, and performs the process of notifying that the positions or orientations between the imaging device and the ranging device are changed if deviation between the first and second plane regions is detected.

13. A position or orientation estimation method performed by a position or orientation estimation apparatus that estimates relative positions or orientations between an imaging device with a ranging function and a ranging device, the method comprising:
detecting a first plane region in an image from image information and first ranging information acquired by the imaging device and detecting a second plane region corresponding to the first plane region from second ranging information acquired by the ranging device; and
estimating positions or orientations of the imaging device and the ranging device by calculating a deviation amount between the first and second plane regions.
